(19) United States
(12) Patent Application Publication
(10) Pub. No.: US 2012/0146764 A1
(43) Pub. Date: Jun. 14, 2012

(54) FINGER LOCK

(76) Inventors: Michael Brent Kitchen, Virginia Beach, VA (US); Peter Michael Johnston, Chesapeake, VA (US)

(21) Appl. No.: 12/966,334

(22) Filed: Dec. 13, 2010

(51) Int. Cl. G05B 19/00; E05B 49/02; E05B 65/00

(52) U.S. Cl. 340/5.51; 70/77

(57) ABSTRACT

The present invention presents a novel security access device, wherein finger movements define a validation code to unlock entryway access in a system comprising an electronic controller directing a servomechanism. Security is enhanced by the finger movements, which are rendered virtually undetectable to an observer, and by the mathematical augmentation of the number of choices for code selection. Alternative embodiments present both a novel system and a novel method for validating access.

### FIELD OF THE INVENTION

This invention relates to electronically-controlled locking mechanisms, and more particularly, to the encoding devices used in such mechanisms.

### BACKGROUND OF THE INVENTION

Keyless locking systems were developed in response to the principal disadvantage inherent in the keyed system, that of losing possession of the key. Possession of the key, which has been replaced in some modern circumstances with a magnetic card, identified a uniquely-privileged person, but the loss or theft of the key could compromise the security or utility of the system. An early example of such a system is the ubiquitous tumbler lock. Instead of using a key, a code is entered by means of a rotating dial. Utility, however, depends upon memory, which is far from infallible, and the demand for security requires that the lock be changed, or mechanically reset, to transfer the privilege to another person.

The security burden becomes a particular concern where a number of people share the privilege of access, such as in a business or in another controlled-access environment of a public nature. The development of electronically-controlled locking mechanisms, wherein the setting and resetting of the code can be managed centrally, makes it easier to accommodate personnel changes or to invalidate stale codes. The current state-of-the-art utilizes a key pad similar to that of a push-button phone, or the number pad on a computer or cell phone, to enter a number sequence for the code. Exemplary art can be found in U.S. Pat. No. 6,760,964 to Gartner, U.S. Pat. No. 7,336,150 to Gokcebay et al, U.S. Pat. No. 5,609,051 to Donaldson, U.S. Pat. No. 4,901,545 to Bacon et al, and in U.S. Patent Application 2006/0065027 to Valentine.

While the current version of the electronic lock offers advantages in flexibility, it does not entirely satisfy the growing concern for increased security. The number pad is essentially in public view while being manipulated and it cannot defeat expert spying, either through visual line-of-sight or through electronic means. One attempt to address this concern can be found in U.S. Patent Application 2006/0037373 to Case et al, hereinafter “Case”.

Case acknowledges the disadvantage of trying to blind the key pad from view. The person entering the code typically prefers to do so by visual means and there is tension between concealment and inconvenience. Case strikes a balance by providing side shields to the pad. This, in effect, reduces the angle of visibility to essentially that of directly overhead. While this might eliminate spying from a location outside of the sector of peripheral vision, it is not a robust solution to the spying problem in the current world of technical eavesdropping.

Keyless locks also require committing a number code to memory. Theoretically, the level of security is dependent upon the number of digits entered in sequence. Typically, the number is limited to four digits because of the increased difficulty of remembering long sequences, particularly when random choice is used. Assuming that a key pad, for example, has a full set of ten touch keys, each digit indexes the number of possibilities by a power of ten. In the case of a four-digit code, the number of possibilities is 10⁴, or 10,000. This means that 10,000 iterations would have to be tried to break the code by trial and error. This is not a particularly large safety margin in the current world of computerized code-breaking algorithms.

For high security systems, it is desirable to increase the number of code possibilities without also increasing the length of the code and further taxing the memory required to retain it. This could be done by increasing the number of possibilities for each digit selection. Expanding the number pad beyond ten keys, however, is not a practical solution. Not only does it increase the territorial layout of the system, thereby further exposing it to unauthorized observation, but it also defeats the attempt to improve memory accuracy by expanding the field of possible numbers to remember. Most people would find it difficult to memorize a “Pick-4” lottery number, for example, based on a random selection from 1 to 36.

The art field of electronic locks lacks a system that leverages the number of code possibilities while simultaneously reducing the role of, and consequently the unreliability of, memory. The art field also has a need for a system where actuation of the code is totally shielded from surreptitious spying. The novel features of the present invention address these, as yet, unfilled requirements of a high-performance security system.

### SUMMARY OF THE INVENTION

It is an object of the present invention to base a validation system for unlocking any secured environment, and especially a lock-secured entryway, on the physical displacement of the fingers of a hand, rather than on the digital entry of a number code. It is a further object that such displacement be hidden from view, and that visibility is not required for the system user, such that operation thereof is based entirely upon touch sensation. It is a further object that the selection possibilities for any one qualifying displacement movement exceed ten choices, and preferably include at least twenty choices, whereby the base of the number having a power exponent is, at minimum, twenty. It is a further object to reduce, or eliminate, the need for battery power in, at least, the operation of the validation system. It is a further object to provide environmental protection for the system, and, in particular, to render the system inherently waterproof. It is a further object to reduce the territorial expanse required for a security access device of such a validation system to the linear arrangement of four fingers of one hand.

These objectives, and others to be discovered through further disclosure herein, and through practice of the invention, are embodied in a security access device for an electronically-controlled lock comprising a plurality of pods arrayed essentially in a line to receive one of the fingertips of a person's hand, wherein the pods are enclosed in a housing. Each pod has sidewalls defining an interior space. The space is configured to receive a fingertip to a depth whereby the direction of movement of the fingertip cannot be discerned to someone observing the scene. A means for detecting fingertip movement in a preferred direction is provided. Also provided is a means for communicating data representing the fingertip movement to an electronic controller. The electronic controller is enabled to pass an unlock command to the lock when a preferred sequence of movements selected from the universe of possible permutations of preferred directions and pods is entered into the device by concealed fingertip movement within the pods.

In a preferred embodiment, there are four pods corresponding to the four non-thumb phalanges of the hand. Also, in the preferred embodiment, there are five preferred directions. The five, with reference to a vertical placement of the device, are “right”, “left”, “up”, “down” and “in”, giving twenty possible permutations when combined with the choice of pods. Also, in the preferred embodiment, the means for detecting fingertip movement is a tactile sensor, defined as an electro-mechanical switch in a particularly preferred embodiment, located within the housing and placed along each of the preferred directions in each pod within reach of the fingertip. Also, in the preferred embodiment, the means for communicating is wired electrical signals.

In an alternate embodiment, a validation system for an electronically-controlled lock comprises a programmable electronic controller, the security access device described herein above, and a preferred sequence of movements selected from the twenty possible permutations. The validation system further comprises digital memory in communication with the electronic controller capable of storing data representing the preferred sequence of movements and data input from the means for communicating. The validation system further comprises programming software for the electronic controller having the capability to compare current data input in time to the preferred sequence of movements and, in the event of a match, to pass a command to a servomechanism to unlock the lock. Lastly, the validation system comprises one or more power supplies to provide electric to the system.

In another alternate embodiment, a method of validating access to an electronically-controlled security system comprises the following steps:

a) providing a programmable electronic controller;

b) providing the security access device described herein above;

c) providing digital memory storage in communication with the electronic controller;

d) selecting a preferred pod;

e) selecting one of the five preferred directions in the preferred pod;

f) repeating the above two selection steps until a predetermined number of preferred movements is selected, the number of preferred movements representing a validation code;

g) communicating the validation code to the electronic controller in an initialization scenario for retention in the digital storage;

h) programming the electronic controller with software capable of processing the initialization scenario, comparing incoming data in time to the validation set and, in the event of a match, to pass a command to a servomechanism to unlock the lock;

i) powering the system; and

j) entering the validation code to gain access

As this is not intended to be an exhaustive recitation, other embodiments may be learned from practicing the invention or may otherwise become apparent to those skilled in the art.

### DESCRIPTION OF THE DRAWINGS

Various other objects, features and attendant advantages of the present invention will become fully appreciated as the same becomes better understood through the accompanying drawings and the following detailed description, in which like reference characters designate the same or similar parts throughout the several views, and wherein:

FIG. 1 is a perspective view of the security access device of the present invention;

FIG. 2 is a perspective view of the security access device with the finger pods removed;

FIG. 3 is an exploded view of the security access device;

FIG. 4 is a plan view of the security access device;

FIG. 5 is a sectional view taken along the lines 5-5 of FIG. 4;

FIG. 6 is a block diagram of the validation system of the present invention, showing electrical connections for the security access device; and

FIG. 7 is a process flow diagram of the method of validating access to a security system.

### DETAILED DESCRIPTION OF THE PREFERRED EMBODIMENT

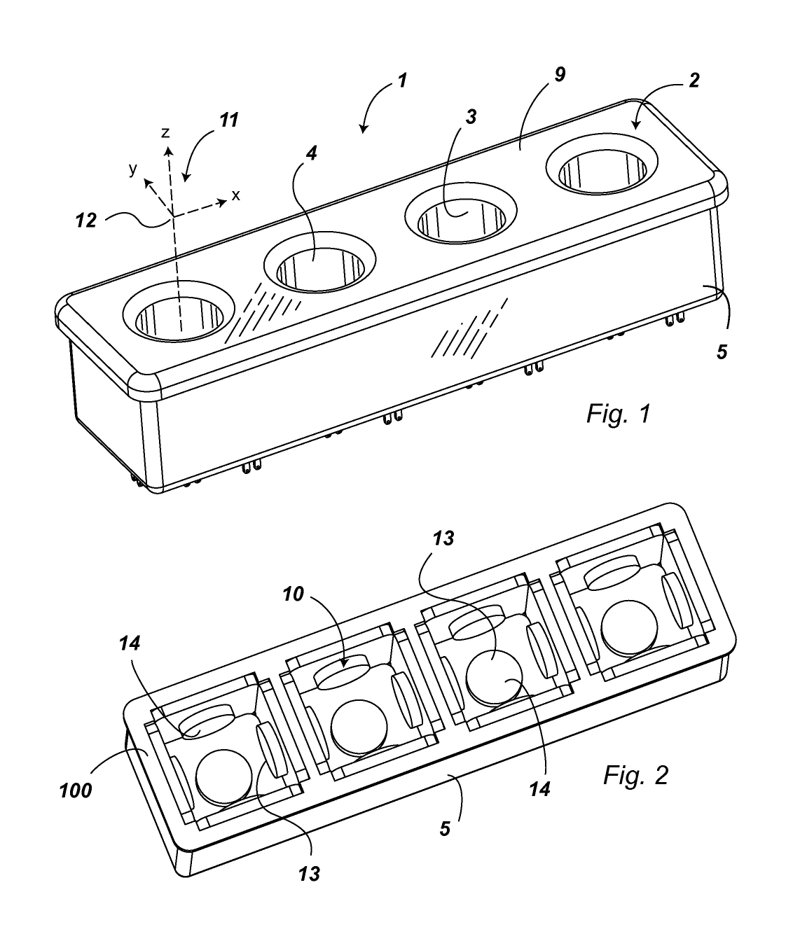

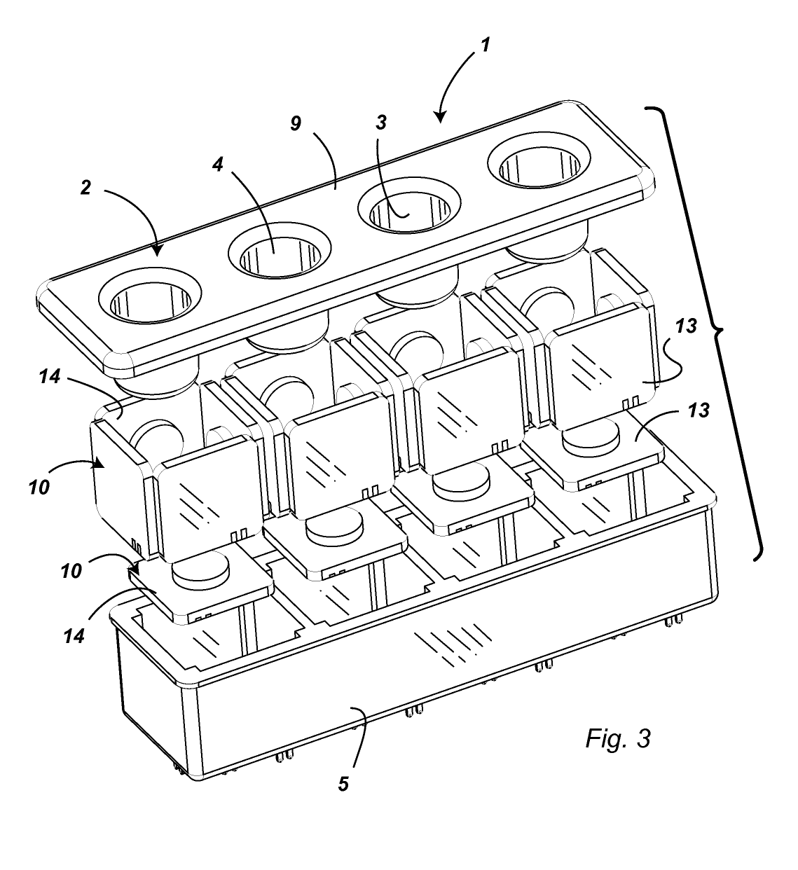

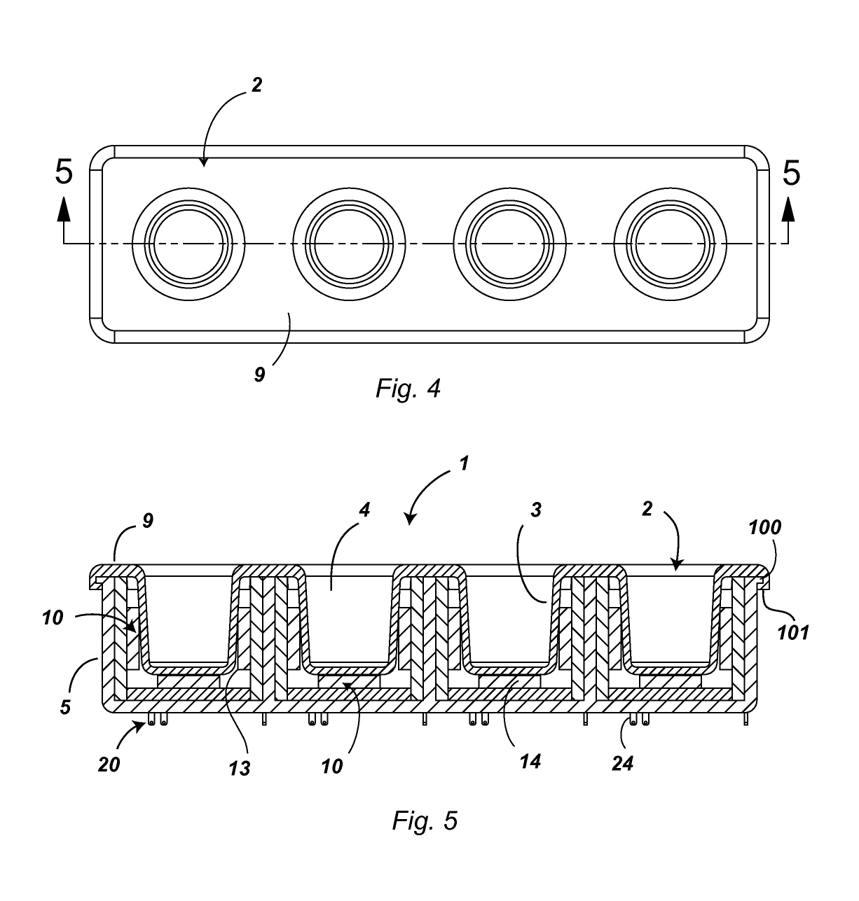

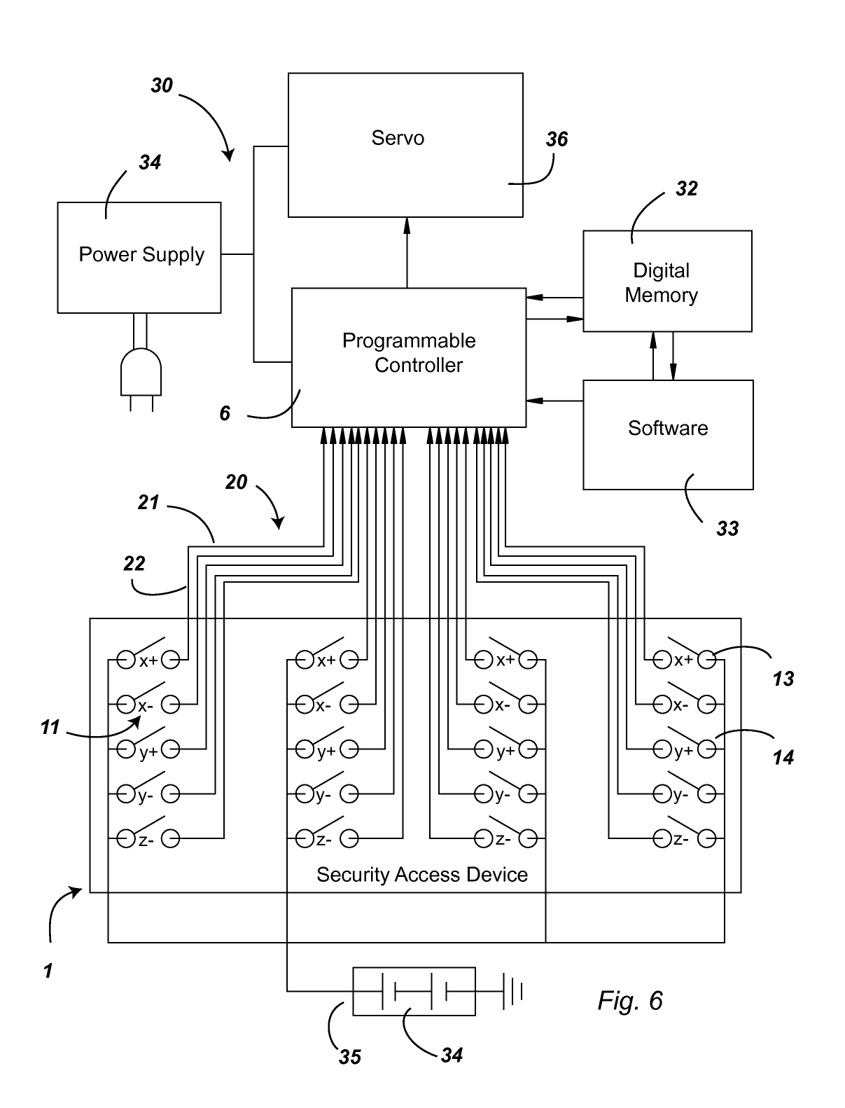

As shown in FIGS. 1 and 3, a security access device 1 is comprised of finger pods 2 and a housing 5 enclosing said finger pods. The security access device 1 is further comprised of a means for detecting fingertip movement 10, best shown in FIGS. 2 and 3, and a means for communicating data 20, best shown in FIGS. 5 and 6.

Referring to FIGS. 1, 3 and 5, the finger pods 2 are comprised of a plurality of individual pods, each having sidewalls 3 defining an interior space 4. The interior space 4 is adapted for receiving a fingertip of a person's hand (not shown). To operate the device, the fingertip is inserted into one of the pods 2 to a depth where lateral movement therein is substantially concealed. The preferred depth is somewhere between the first and second finger joints from the distal end of the finger, or approximately 1.5″.

In the preferred embodiment, the finger pods 2 are arrayed in an essentially linear configuration accessible to two or more of the non-thumb phalanges of one or more hands. In a particular preferred embodiment, the finger pods 2 are four in number and correspond to the index, middle, ring, and little fingers of one of a person's hands. The invention comprehends that the thumb could be included in an alternate embodiment, said embodiment best conceived in a curvilinear form pursuant to ergonomic considerations.

In the preferred embodiment, the finger pods 2 are unitized in a single molded sheet 9. In a particular preferred embodiment, the molded sheet 9 is comprised of a butyl rubber or a thermoplastic elastomer (TPE) material. The sheet can be compression molded (rubber), injection molded (TPE), or otherwise molded by sheet-molding or rapid-prototyping techniques. The inherent flexibility of such a construction permits the finger pods 2 to be manipulated in any direction by fingertip defection.

The periphery of the elastic molded sheet 9 may overlap a flange 100 of housing 5 (FIG. 5) to form, in an under lap portion, what effectively becomes a gasket 101. When mounting the security access device 1 to a surface, the gasket 101, combined with the unitary construction of the molded sheet 9, substantially renders the device isolated from the external environment; and, in particular, protects in the internal environment from moisture penetration.

When the fingertips are inserted into the finger pods 2, the longitudinal extent of that portion of the finger inside defines the z-axis of a virtual orthogonal reference system 12, wherein the axes are nominally designated “x”, “y” and “z” (FIG. 1). In order to perform an encoding act, the fingertips are moved sequentially in one of preferred directions 11. In the preferred embodiment, the preferred directions 11 number five, and are expressed, in terms of the virtual reference system 12, as x+, x−, y+, y−, and z−, following conventional notation for the positive and negative directions of the axes. With a vertical mounting of the security access device 1, the preferred directions 11 might be restated as “right”, “left”, “up”, “down”, and “in”. The invention comprehends any set of directions for the preferred directions, as long as the angular separation is sufficient to eliminate problems discriminating one direction from another. Furthermore, any multiplicity in the set may be used. The preferred set of five, however, is easily remembered and can be performed with accuracy.

Any of the preferred directions 11 can be chosen by movement of any fingertip in any pod to form an element of a validation code 102 (not shown). In the preferred embodiment, the choices, among five directions and four pods, number twenty for the first element. Because any of the choices can be repeated, the second element of the validation code 102 also numbers twenty, and so on for each additional element comprising the code. In the preferred embodiment, the validation code 102 is comprised of four elements, and the permutation of choices numbers 20 times 20 times 20 times 20, or 20⁴, or 160,000 in expanded form. The movements comprising the code are detected in sequence by the means for detecting 10 and are communicated to a programmable electronic controller 6 by the means for communicating 20. The programmable controller 6 (FIG. 6), upon verifying the entered code, can then issue a command to unlock a locking mechanism 7 (not shown).

The security of any system could be enhanced by adding additional elements to the validation code 102. For example, a 20-element code would have 20²⁰ permutations, a number far too large to consider discovery by indexing the permutations. As a practical matter, the four elements of the preferred code of the present invention are already superior to that of a comparable code based on a digital number pad, such as that on a computer keyboard, a phone, a calculator, or a key pad of a prior art lock. The twenty choices per element are twice that of the nominal 10-digit key pad, but the permutations are 16 times greater, the base of the power (i.e., 20) giving greater leverage to the calculation. The key pad alternative would have to have a five-element code to approach the same order of magnitude of permutations. The choice of four elements in the preferred embodiment is a pragmatic one, balancing the taxation of memory against the benefit in security. The present invention is thusly more memory-friendly than that of prior art systems having a comparable security profile.

Further to the security aspect, the entry of the validation code 102 in the security access device 1 is virtually undetectable by direct observation from an unauthorized interloper. This is because movement is substantially invisible in the interior space 4. By contrast, in the key pad alternative, the keys, exposed by operational necessity, and arrayed by order convention, are ultimately revealing, notwithstanding the indicia normally found thereon, and any spy with a line-of-sight can pirate the code. Moreover, the system user typically needs to see the key pad to enter a code, placing the additional burden of lighting, in low-light circumstances, on battery-powered systems.

Further layers of security could be added, in addition, to thwart electronic eavesdropping. For example, the security access device 1 could be provided with a Faraday cage by enveloping the device in a conductive mesh. This would simultaneously prevent detection of electromagnetic (EM) emissions during transmissions, and prevent introduction of malicious code by external means.

Still further to the security aspect, muscle memory plays a central role in the present invention where movement, and not character association, is the operative feature. It is well known that muscle memory is processed in a different location in the brain from that of the memory, for example, of a number sequence. Muscle memory accounts for how a person can still ride a bike after a long absence, or how a piano player can play music without having to think of which piano key to strike. Muscle memory is superior in many ways because it involves an autonomic response, and is free from the thinking process, which is often cluttered with thoughts and subject to short-term lapses. Because a system user is not trying to remember a number, the thinking part of the brain is less involved in the recordation and recovery processes. In addition to being failure-prone, the thinking process gets in the way, as well known by athletes, who often regress in performance when “going mental”. The present invention enhances memory processing while, at the same time, lowering demands on the conscious memory part of the brain, and makes security both more reliable and more accessible as a result.

It should be noted that, in the above discussion, the validation code 102 is comprised of sequential movements. The present invention also comprehends that the code elements could be simultaneous entries of two or more movements. This would exponentially increase the base number, and therefore, the number of permutations, but such complexity is hardly justifiable in view of the already enhanced capabilities of the preferred embodiment. In an alternative embodiment, however, the simultaneous movement format could be used to differentiate different classes of system privilege, or of different user groups, without compromising the range of choices for the validation code 102.

Referring to FIGS. 2, 3 and 5, the housing 5 encloses the finger pods 2 and preferably encloses the means for detecting movement 10, as well. In the preferred embodiment, the means for detecting movement 10 comprises tactile sensors 13, which correspond in number and position to each of the preferred directions 11 in each of the finger pods 2. In a particular preferred embodiment, the tactile sensors 13 comprise electro-mechanical switches 14 aligned with the x+, x−, y+, y− and z-directions, each within range of fingertip movement thereto. The present invention comprehends that the means for detecting movement 10 could be integrated with the finger pods 2. In the particular preferred embodiment, however, the electro-mechanical switches 14 are fixtured in a cell-like arrangement of the housing 5.

In an alternate embodiment, the tactile sensors 13 might comprise one or more of the touchscreen technologies currently found in such electronic devices as GUI's (graphical user interface), PDA's (personal digital assistant), GPS's (global positioning system), cell phones and computers. Such technologies could include those of the capacitive, resistive, infrared, and surface acoustic wave types, all of which detect a touch event, and some of which may detect an increase in pressure. One alternate embodiment of particular interest is that based on acoustic pulse recognition technology, which uses a piezoelectric transducer to generate an electrical signal. Because the signal is generated in such piezoelectric transducers by mechanical means, use of such technology for the tactile sensors 13 could reduce dependence upon, or eliminate altogether, any external power required to generate the signal. This would render a system free from the failure mode wherein a power source, such as a battery, becomes weak, depleted, or otherwise shutdown.

The means for detecting movement 10 generates signals, each signal indicating a specific movement event, to be received by the programmable electronic controller 6. The signals are transmitted by the means for communicating 20, best shown in FIGS. 5 and 6. In the preferred embodiment, the means for communicating 20 comprises wired electrical signals 21. The wired electrical signals 21 are charge pulses from the tactile sensors 13, which are sent along wires 23 through a circuit comprising spade contacts 24 (FIG. 5) when the tactile sensors 13, in electrical contact with the spade contacts 24, are actuated by movement in one of the preferred directions 11. In an alternate embodiment, the means for communicating 20 is comprised of wireless EM signals 22 (not shown), which are wave signals transmitted to a receiver in the programmable electronic controller 6. Such an alternate embodiment might be subject to malicious surveillance, however, unless both the controller and the access device are encased in a Faraday cage.

The housing 5 may be fabricated from non-conducting material. In the preferred embodiment, the housing 5 may be injection molded from any of a variety of non-polar polymer resins, including polyethylene (PE), polystyrene (PS), polypropylene (PP), polyvinyl chloride (PVC), or mixtures or blends thereof. The spade contacts 24 may be insert molded in the same process.

The present invention is alternately embodied in a validation system 30 for an electronically-controlled lock, best shown in FIG. 6. The validation system 30 comprises the programmable electronic controller 6, the security access device 1, and a preferred sequence of movements 31 (not shown) selected from among the possible permutations of the preferred directions 11 and the finger pods 2, said preferred sequence defining the validation code 102. In a particular embodiment, the movements of the preferred sequence of movements 31 number at least four, and the possibilities for selection number at least 20⁴, or 160,000.

The validation system 30 further comprises a digital memory 32 in signal communication with the electronic controller 6. The digital memory 32 has the capability of storing data representing the preferred sequence of movements 31 and data input from the means for communicating 20. The validation system 30 further comprises programming software 33, said software having the capability to compare current data input in time to the preferred sequence of movements 31; and, in the event of a match, to pass a command to a servomechanism 36 to unlock the lock. In a particular embodiment, the programming software 33 further comprises the capability of resetting the preferred sequence of movements 31 when presented with a master code.

Lastly, the validation system 30 comprises one or more power supplies 34 to provide the system with electric power. Battery 35, powering security access device 1 in what might be a remote location, is a constituent of the power supplies 34. The need for battery 35 might be reduced or eliminated through the use of piezoelectric technology in the means for detecting movement 10.

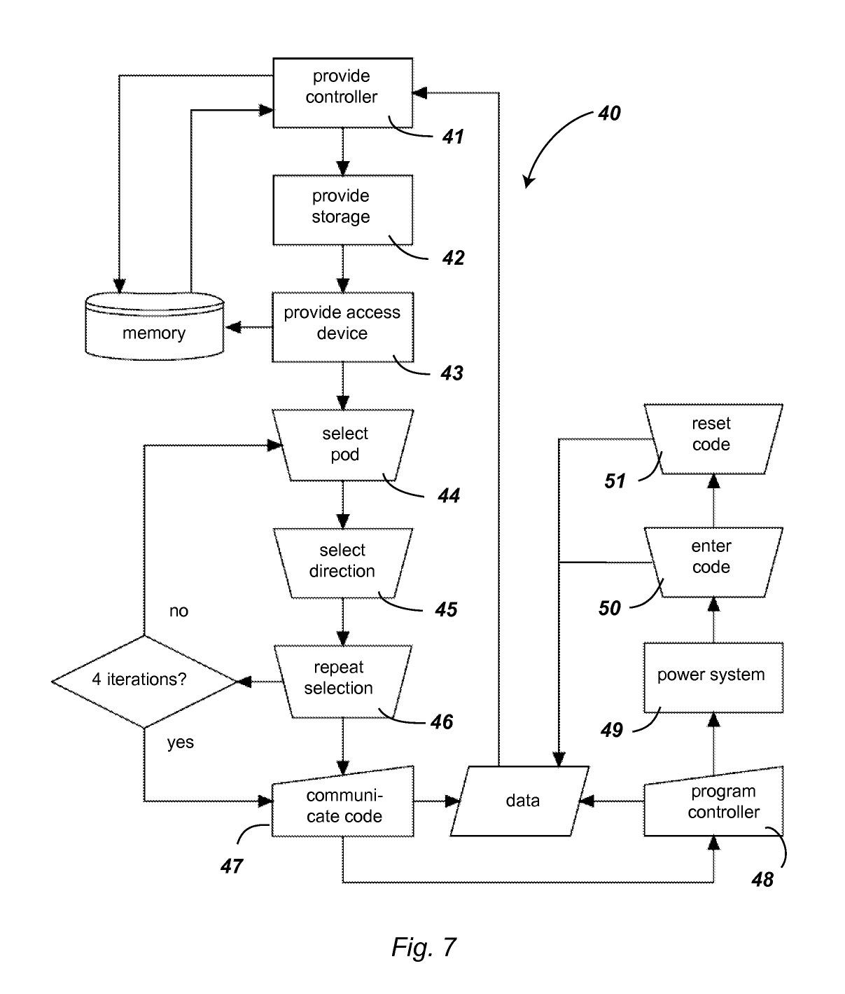

The present invention is additionally alternately embodied in a method of validating access 40 to an electronically-controlled security system, best shown in FIG. 7. The method of validating access 40 comprises the following, in no particular order, except where indicated by sequence:
Step a) 41 to provide the programmable electronic controller 6;
Step b) 42 to provide the security access device 1;
Step c) 43 to provide the digital memory 32;
Step d) 44 to select one of the finger pods 2;
Step e) 45 to select one of the preferred directions 11;
Step f) 46 to repeat steps d) 44 and e) 45 until the number of select movements reaches the preferred sequence 31 and defines the validation code 102;
Step g) 47 to communicate the validation code 102 to the electronic controller 6 in an initialization scenario for retention in the digital memory 32;
Step h) 48 to program the electronic controller 6 with the programming software 33 capable of processing the initialization scenario, comparing the incoming data in time to the validation code 102; and, in the event of match, to pass a command to the servomechanism 36 to unlock the lock;
Step i) 49 to power the system with power supplies 34; and
Step j) 50 to enter the validation code 102 in the security access device 1.

In a particular embodiment, the method of validating access 40 further comprises:
Step k) 51 to reset the validation code 102 upon presentation of a master code to the electronic controller 6.

It is to be understood that the invention is not limited in its application to the details of construction and to the arrangements of the components set forth in the preceding description or illustrated in the drawings. For example, the pods 2 may be arrayed in alternate configurations for use by fingers of both hands. Also, it is to be understood that the phraseology and terminology employed herein are for the purpose of the description and should not be regarded as limiting.

What is claimed is:

1. A security access device for an electronically-controlled lock, comprising:
a plurality of pods arrayed essentially in a line to receive fingertip's of a person's hand, each pod having sidewalls defining an interior space, said interior space configured to receive one of the fingertips to a depth whereby the direction of movement of said fingertip inside the pod is not discernable to an observer;
a housing enclosing the plurality of pods;
a means for detecting fingertip movement in a preferred direction within each pod; and
a means for communicating data representing said fingertip movement to an electronic controller;
whereby the electronic controller is enabled to issue a pass command to the lock when a preferred sequence of movements selected from the universe of possible permutations of preferred directions and pods is entered into the device by concealed fingertip movement within the pods.

2. The device of claim 1, wherein the number of pods is four.

3. The device of claim 1, wherein the preferred directions number five and are defined, in terms of an orthogonal reference system with the z-axis aligned with the fingertip, as x+, x−, y+, y−and z−.

4. The device of claim 3, wherein the means for detecting fingertip movement is a tactile sensor located within the housing and placed along each of the preferred directions in each pod within reach of the fingertip.

5. The device of claim 4, wherein the means for communicating is wired electrical signals.

6. The device of claim 4, wherein the means for communicating is wireless electromagnetic signals.

7. The device of claim 4, wherein the tactile sensor is an electro-mechanical switch.

8. The device of claim 5, wherein an enclosure comprising the pods and the housing constitutes, effectively, a Faraday shield.

9. The device of claim 1, wherein an enclosure comprising the pods and the housing is moisture proof.

10. A validation system for an electronically-controlled lock, comprising:
a programmable electronic controller;
a security access device comprising four pods arrayed essentially in a line to receive fingertip's of a person's hand, each pod having sidewalls defining an interior space, said interior space configured to receive one of the fingertips to a depth whereby the direction of movement of said fingertip inside the pod is not discernable to an observer; a housing enclosing the pods; a means for detecting fingertip movement in five preferred directions within each pod, said directions defined, in terms of an orthogonal reference system with the z-axis aligned with the fingertip, as x+, x−, y+, y− and z−; and a means for communicating data representing said fingertip movements to the electronic controller;
a preferred sequence of movements selected from among the twenty permutations of preferred directions and pods;
digital memory in communication with the electronic controller capable of storing data representing the preferred sequence of movements and data input from the means for communicating;
programming software for the electronic controller, the software having the capability to compare current data input in time to the preferred sequence of movements and, in the event of a match, to pass a command to a servomechanism to unlock the lock; and
one or more power supplies for powering the system.

11. The system of claim 10, wherein number of movements in the preferred sequence of movements is at least four, and the range of possibilities is at least 204.

12. The system of claim 10, wherein the means for detecting fingertip movement is a tactile sensor placed along each of the preferred directions in each pod within reach of the fingertip.

13. The system of claim 12, wherein the means for communicating is wired electrical signals.

14. The system of claim 12, wherein the means for communicating is wireless electromagnetic signals.

15. The system of claim 12, wherein the tactile sensor is an electro-mechanical switch.

16. The system of claim 10, wherein the programming software further comprises the capability of resetting the preferred sequence of movements when presented with a master code.

17. A method of validating access to an electronically-controlled security system, comprising the steps of:
providing a programmable electronic controller;
providing a security access device comprising four pods arrayed essentially in a line to receive fingertip's of a person's hand, each pod having sidewalls defining an interior space, said interior space configured to receive one of the fingertips to a depth whereby the direction of movement of said fingertip inside the pod is not discernable to an observer; a housing enclosing the pods; a means for detecting fingertip movement in five preferred directions within each pod, said directions defined, in terms of an orthogonal reference system with the z-axis aligned with the fingertip, as x+, x−, y+, y− and z−; and a means for communicating data representing said fingertip movements to the electronic controller;
providing digital memory storage in communication with the electronic controller;
selecting a preferred pod;
selecting one of the five preferred directions in the preferred pod;
repeating the above two selection steps until a predetermined number of preferred movements is selected, said number of preferred movements representing a validation code;
communicating the validation code to the electronic controller in an initialization scenario for retention in the digital memory;
programming the electronic controller with software capable of processing the initialization scenario, comparing incoming data in time to the validation code and, in the event of a match, to pass a command to a servomechanism to unlock the lock;
powering the system; and
entering the validation code to gain access.

18. The method of claim 17, further comprising the step of resetting the validation code upon presentation of a master code to the electronic controller.

19. The method of claim 17, wherein the predetermined number of preferred movements is at least four, and the number of possibilities for the validation code is at least 160,000.
